(19) United States
(12) Patent Application Publication
(10) Pub. No.: US 2024/0339947 A1
(43) Pub. Date: Oct. 10, 2024

(54) Method for operating a power supply circuit in an inverter for driving an electric machine, computing unit, power supply circuit in an inverter and inverter

(71) Applicant: SEG Automotive Germany GmbH, Stuttgart (DE)

(72) Inventors: Nima SAADAT, Stuttgart (DE); Murugaperumal DEVARAJA, Stuttgart (DE)

(21) Appl. No.: 18/626,168

(22) Filed: Apr. 3, 2024

(30) Foreign Application Priority Data
Apr. 4, 2023 (DE) 102023108606.5
May 30, 2023 (DE) 102023114083.3

(51) Int. Cl. H02P 27/06; B60R 16/03

(52) U.S. Cl. CPC H02P 27/06; B60R 16/03; H02P 2201/07

(57) ABSTRACT

A power supply circuit in an inverter for driving an electrical machine has a high-voltage branch with a high-voltage level and a low-voltage branch with a low-voltage level, the high-voltage level being higher than the low-voltage level, the high-voltage branch being connected to the low-voltage branch via an operating DC/DC converter, the low-voltage branch having a supply branch and a mains branch, the high-voltage branch being connected to the mains branch via a discharge DC/DC converter. A method for operating the power supply circuit includes, in a first operating mode conducting current from the high-voltage branch via the operating DC/DC converter into the supply branch, and in a second operating mode, conducting current from the high-voltage branch via the discharge DC/DC converter into the mains branch.

### CROSS-REFERENCE TO RELATED APPLICATIONS

This application claims priority to German Patent Application Nos. 102023108606.5 filed Apr. 4, 2023, and 102023114083.3 filed May 30, 2023, both of which are hereby incorporated by reference.

### TECHNICAL FIELD

The present disclosure relates to a method for operating a power supply circuit in an inverter for driving an electric machine, a computing unit for carrying out the method, a power supply circuit in an inverter and an inverter.

### BACKGROUND

A power supply circuit of an inverter or in an inverter is also referred to as a PDN or PDTN (power distribution network or power distribution tree network) in modern vehicle applications with an electric drive. The task of this power distribution network is, among other things, to distribute power to the various components or consumers of the inverter, such as sensors, communication circuits (e.g. CAN, LIN transceivers) and in particular the gate driver circuits for high-side (HS) and low-side (LS) switches, and functional safety circuits or MCU (microcontroller unit), etc. In this sense, the inverter is a device which internally has the power supply circuit and components supplied by it, including switches, e.g. in the form of half bridges, and terminals for connecting external power sources and an electrical machine.

Nowadays, due to functional safety requirements, there can be two main power sources for the PDN. A common power source in electric vehicles (EV) is low-voltage batteries (e.g. 12 V), also known as the KL.30 network or low-voltage branch. A second source can be a high-voltage DC battery or the high-voltage DC bus (high-voltage branch) with a nominal voltage of 400 V to more than 1,000 V, for example. Such high-voltage, HV, networks can be used in particular as a power supply for an electric traction drive, such as a permanent magnet synchronous motor (PMSM), which is connected to the high-voltage branch via the inverter.

However, the use of an HV drive train increases the risk of electric shock, particularly in the event of accidents. The ECC R94 standard therefore requires that the DC bus capacitor voltage should drop to a safe voltage (maximum 60 V) in less than 5 seconds.

U.S. Pat. No. 7,768,237 B2 and U.S. Pat. No. 9,637,009 B2 each describe a discharge circuit with a series connection of a switch and a resistor.

DE 10 2007 022 515 A1 describes the discharging of an intermediate circuit capacitor via an inverter.

DE 10 2004 057 693 A1 shows a device for rapidly discharging a capacitor, in particular an intermediate circuit capacitor, via a DC/DC converter in an on-board electrical network with a starter generator as the electrical machine and an associated voltage converter, in which a controlled or regulated DC/DC converter is used as the DC/DC converter, the output voltage of which on the vehicle electrical network side is raised relative to the normal state after the electrical machines are switched off and the inverter is switched off, as a result of which the charges to be discharged are supplied to the battery connected to the voltage converter.

### SUMMARY

According to the disclosure, a method for operating a power supply circuit in an inverter for controlling an electrical machine, a computing unit for carrying out the method, a power supply circuit in an inverter and an inverter with the features of the independent patent claims are proposed. Advantageous embodiments are the subject of the dependent claims and the following description. It should be emphasized that the features and advantages described below apply equally to the power supply circuit and the method for operating such a circuit.

The power supply circuit in the inverter has two different branches, namely a high-voltage branch and a low-voltage branch. The high-voltage branch is designed to be connected to a high-voltage network (in particular in the vehicle), and the low-voltage branch is designed to be connected to a low-voltage network (in particular in the vehicle), with a nominal voltage level of the high-voltage network being higher than a nominal voltage level of the low-voltage network. The high-voltage branch and the low-voltage branch have corresponding terminals for connecting to the high-voltage network or low-voltage network. In particular, these terminals are led out of a housing of the inverter. The nominal voltage level of the high-voltage network (hereinafter also referred to as the high-voltage level) can, for example, be significantly higher than a permissible touch voltage of 60 V in particular, e.g. up to several hundred volts. The nominal voltage level of the low-voltage network (hereinafter also referred to as the low-voltage level) can, for example, correspond to standard vehicle low voltages of 12 V or 24 V, for example. The low-voltage branch is used or set up to distribute power to the components or consumers of the inverter, such as sensors, communication circuits (e.g. CAN, LIN transceivers) and in particular the gate driver circuits for high-side (HS) and low-side (LS) switches, logic circuits (such as discrete or integrated circuits (e.g. IC, ASIC) or so-called MCU (microcontroller unit)) and functional safety circuits etc.

The low-voltage branch has a supply branch and a mains branch, whereby the mains branch is used to connect to the low-voltage network and the supply branch is used to distribute current to the components or loads of the inverter.

The disclosure describes a way of reducing a high and dangerous voltage of the high-voltage network in the vehicle in the event of a fault, e.g. in the event of an accident involving the vehicle or in the event of a fault or failure of the inverter, in a single device, namely the inverter, by simple means to a permissible touch voltage value of at most 60 V, which is specified here by the low-voltage level. The invention requires only very few regular components and can therefore be realized very simply and cost-effectively, also with regard to the control. The invention is implemented in the inverter for controlling the electric machine in the vehicle and is therefore very easy to implement in a vehicle without the need for further or additional components.

The invention makes use of the measure of discharging the high-voltage network (which is connected to the high-voltage branch of the inverter) via the discharge DC/DC converter of the inverter discharge DC/DC converter into the mains branch of the inverter power supply circuit and thus into the low-voltage network—in particular in the event of a fault—to reduce the high-voltage voltage to the low-voltage level.

The method comprises conducting current from the high-voltage branch via the operating DC/DC converter to the supply branch in a first operating mode (hereinafter also referred to as normal operating mode), whereby no current is conducted from the high-voltage branch via the discharge DC/DC converter to the mains branch, and conducting current from the high-voltage branch via the discharge DC/DC converter to the mains branch in a second operating mode (hereinafter also referred to as discharging mode).

In the normal operating mode, in particular, no current is conducted from the high-voltage branch via the discharge DC/DC converter into the mains branch, whereas in the discharging mode, current can still be conducted from the high-voltage branch via the operating DC/DC converter into the supply branch, or not.

In one embodiment, the supply branch, the mains branch and the operating DC/DC converter are electrically connected via a blocking circuit in such a way that a current flow from the supply branch into the operating DC/DC converter is blocked, a current flow from the supply branch into the mains branch is blocked and a current flow from the mains branch into the operating DC/DC converter is blocked. This prevents mutual negative interference.

If the energy is transferred from the high-voltage network to the low-voltage network, it does not harm people in terms of the voltage level. The energy can be used there to supply consumers or stored in a low-voltage energy storage device (e.g. battery). If possible, the energy can also be reused if the fault condition can be rectified quickly. In a third operating mode, energy can be fed back from the mains branch into the high-voltage branch (and via this into a connected high-voltage network), whereby the discharge DC/DC converter in this case is advantageously a bidirectional DC/DC converter. If necessary, a further feed-back DC/DC converter could also be provided.

Operating DC/DC converter and discharge DC/DC converter can be implemented using the same DC/DC converter. This allows parts and components to be saved.

In one embodiment, the discharge DC/DC converter is a non-isolating DC/DC converter, such as a buck converter, synchronous converter, SEPIC converter (single ended primary inductance converter), Ćuk converter, zeta converter, etc. With non-isolating DC/DC converters, there is no electrical isolation between the input network and the output network. These are usually inexpensive to use.

In one embodiment, the discharge DC/DC converter is an isolating DC/DC converter, such as a fly-back converter, forward converter, push-pull converter, etc. With insulating DC/DC converters, there is galvanic isolation between the input network and the output network, which is usually achieved by means of a transformer. These have increased safety, but are more complex in terms of weight, installation space and costs. In the high-voltage range (>60 V), the use of an insulating DC/DC converter is advantageous or even mandatory for safety reasons.

In one embodiment, the discharge DC/DC converter is a bidirectional DC/DC converter. In this case, energy stored in the low-voltage network can advantageously be fed back into the high-voltage branch. In one embodiment, current is thus fed from the mains branch via the discharge DC/DC converter into the high-voltage branch in a third operating mode.

In one embodiment, a current intensity of a current flowing into the mains branch is regulated, in particular in the second operating mode. This can prevent an overload or damage to the mains branch or the low-voltage network connected to it. Regulation can be achieved, for example, by the discharge DC/DC converter itself, if it is operated in a constant current mode, or by controlling a semiconductor switch arranged in the current path. In the latter case with an additional semiconductor switch, the discharge DC/DC converter can advantageously continue to be operated in a constant voltage mode.

In one embodiment, a discharge circuit is provided which has a mains branch disconnector to connect the mains branch to the discharge DC/DC converter and disconnect it from it, and/or a supply branch disconnector to connect the supply branch to the operating DC/DC converter and disconnect it from it. This is a very simple measure in terms of design and circuitry in order to realize the different operating modes mentioned. The switches can be semiconductor switches or mechanical switches (relays). If the aforementioned switches are realized as semiconductor switches, the current intensity of the current flowing through the switches can also be controlled in conjunction with a current intensity measurement.

In one embodiment, the power supply circuit or the discharge circuit has a blocking circuit to prevent a current flow from the mains branch into the discharge DC/DC converter. This can prevent damage to the discharge DC/DC converter.

In one embodiment, the supply branch disconnector is closed (conducting) and the mains branch disconnector is open (non-conducting) in the first operating mode. This corresponds to normal operating mode, with no current flowing from the high-voltage branch into the mains branch.

In one embodiment, the mains branch disconnector and the supply branch disconnector are closed (i.e. conductive) in the second operating mode. This corresponds to a discharging mode in which energy or current from the high-voltage branch is also used to supply the low-voltage branch and thus to supply the components of the inverter in parallel with discharging.

In one embodiment, the mains branch disconnector is closed (conducting) and the supply branch disconnector is open (non-conducting) in the second operating mode. This corresponds to a discharge mode in which no current flows from the high-voltage branch into the supply branch. In one embodiment, the mains branch disconnector is closed first and the supply branch disconnector is opened with a delay. This serves to maintain an uninterrupted current flow via the DC/DC converter in order to prevent damage to the vehicle electrical network.

A computing unit according to the disclosure, e.g. an integrated circuit (e.g. IC, ASIC or FPGA), is set up, in particular in terms of program and/or circuit technology, to carry out a method according to the disclosure. A power supply circuit of an inverter with such a computing unit and an inverter with such a power supply circuit are also a subject-matter of the disclosure.

This solution is advantageous as the discharge option is integrated directly into the inverter's power supply circuit. Necessary components such as switches, coils, capacitors etc. are already present there. This means that the invention can be advantageously implemented directly in the inverter, which in turn is advantageously structurally connected to an electrical machine and serves to connect the AC voltage terminals of the electrical machine to DC voltage terminals of the vehicle electrical network, in particular the high-voltage branch.

A further advantage is that the energy is not converted into heat in the inverter and therefore no corresponding “heating resistor” and no cooling or heat dissipation is required.

In particular, the power supply circuit has terminals for a high-voltage network and terminals for a low-voltage network and is set up to generate a supply voltage for components of the inverter, in particular from a high-voltage voltage applied to the high-voltage network terminals and/or from a low-voltage voltage applied to the low-voltage network terminals.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 schematically shows a power supply circuit of an inverter, in embodiments.

FIG. 2 schematically shows a further power supply circuit of an inverter, in embodiments.

FIG. 3 schematically shows a discharge circuit, in embodiments.

FIG. 4 schematically shows a current intensity determining device, in embodiments.

FIG. 5 schematically shows a further current intensity determining device, in embodiments.

### DETAILED DESCRIPTION

In the following, embodiments are described in a coherent and comprehensive manner with reference to the figures. In order to reduce the complexity of the figures, not all connections and signal flows are shown. Return lines or ground or negative lines are also not shown in all events.

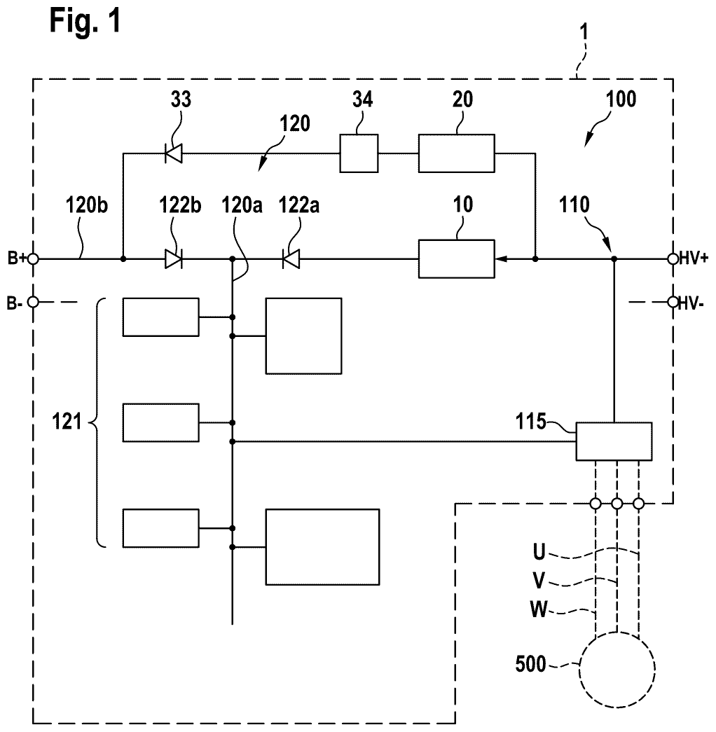

FIG. 1 schematically shows an embodiment of a power supply circuit 100 according to the disclosure in an embodiment of an inverter 1 according to the disclosure. In vehicles, an inverter is usually a component or device that controls the electrical machine. In particular, the inverter can implement torque and speed control and convert the DC voltage on the vehicle electrical network side into AC voltage on the engine side and—in the case of recuperation—vice versa, convert the AC voltage on the engine side into DC voltage on the vehicle electrical network side and feed it into the vehicle electrical network.

The power supply circuit 100 has a high-voltage branch 110 with a high-voltage terminal HV+ for connecting a high-voltage network with a high-voltage level and a low-voltage branch 120 with a low-voltage terminal B+ for connecting a low-voltage network (so-called KI.30 network) with a low-voltage level. The high-voltage level is in the range of 300 V to 1,000 V, for example. The associated negative terminal HV− is indicated. The low-voltage level can be 12 V or 24 V, for example, and is therefore safe to touch. The associated negative terminal B− or vehicle ground is indicated. The use of a high-voltage network in a vehicle increases the risk of electric shock, particularly in the event of an accident. The disclosure therefore provides a way of quickly reducing the voltage present in the high-voltage network to a safe-to-touch level, in this case the low-voltage level, in the event of a fault.

The low-voltage branch 120 has a supply branch 120a, which in the broadest sense serves to supply power to the components of the inverter 1, and a mains branch 120b, which can be connected to the low-voltage network. The supply branch 120a can also be referred to as PDN (see above).

The high-voltage branch 110 is connected to the low-voltage branch 120 via an operating DC/DC converter 10 in order to conduct current to the supply branch 120a if necessary.

The supply branch 120a is connected via diodes 122a, 122b as blocking circuits on the one hand to the operating DC/DC converter 10 and on the other hand to the mains branch 120b.

The supply branch 120a, the mains branch 120b and the operating DC/DC converter 10 are electrically connected via the diodes in such a way that a current flow from the supply branch 120a into the operating DC/DC converter 10 is blocked, a current flow from the supply branch 120a into the mains branch 120b is blocked and a current flow from the mains branch 120b into the operating DC/DC converter 10 is blocked.

The high-voltage branch 110 is also connected to the mains branch 120b via a discharge DC/DC converter 20 in order to conduct current into the mains branch 120b if necessary. In the example shown, a blocking circuit in the form of a diode 33 is provided to prevent a current flow from the mains branch 120b into the discharge DC/DC converter 20. Furthermore, a current intensity determining device 34, e.g. comprising a measuring resistor, can optionally be provided in order to measure and, if desired, also regulate a current flow into the mains branch 120b. The current intensity determining device 34 can be implemented in the discharge DC/DC converter 20.

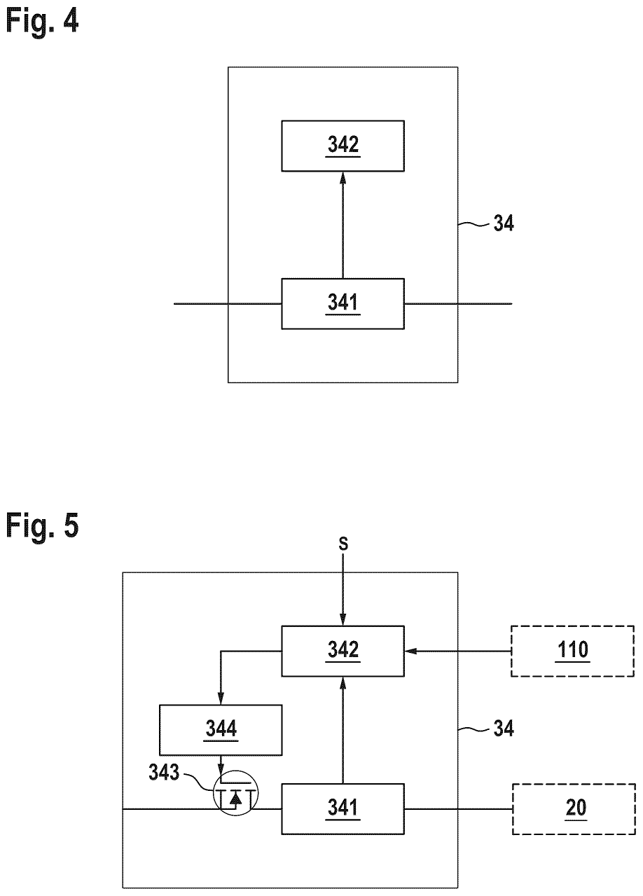

A first embodiment of a current intensity determining device 34 is shown in FIG. 4. It can have a measuring or shunt resistor 341, with the voltage dropping across it being fed to a discharge controller 342, which can be part of the discharge DC/DC converter 20. Thus, the current intensity of the current flowing into the mains branch 120b can be controlled by the discharge DC/DC converter 20, which can accordingly be operated in a constant current mode.

A second embodiment of a current intensity determining device 34 is shown in FIG. 5. It also has the measuring or shunt resistor 341, with the voltage dropping across it being fed to the discharge controller 342. In addition, the current intensity determining device 34 has a semiconductor switch 343, in particular a MOSFET or IGBT, with an associated gate driver circuit 344, which is controlled by the discharge controller 342. Thus, the current intensity of the current flowing into the mains branch 120b can be controlled by the control of the semiconductor switch 343, so that the discharge DC/DC converter 20 can be operated in a constant voltage mode.

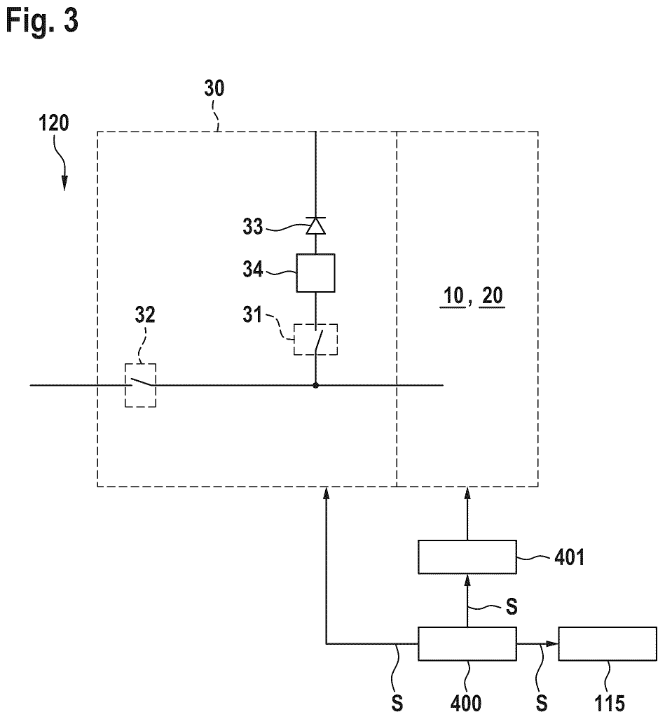

The discharge controller 342 can cause the semiconductor switch 343 to be actuated in accordance with a supplied discharge control signal S, which is triggered, for example, by a safety circuit (e.g. computing unit 400, FIG. 3). The semiconductor switch itself is preferably operated in the amplification range, in particular in the range in which the amplification is approximately linear. In particular, the semiconductor switch operates in the saturation zone. In this case, typical semiconductor switches work like a variable resistor. The gate voltage and thus an electrical resistance of the semiconductor switch is ultimately set in such a way that a desired current flow or a desired current intensity is set from the high-voltage branch 110 to the mains branch 120b.

In normal operating mode, the semiconductor switch 343 is not conductive.

It may further be provided that the discharge controller 342 also monitors the HV voltage in the high-voltage branch 110. This information is generally available in conventional inverters, so that the corresponding sensor can also be used for discharge monitoring. In particular, the discharge circuit monitors the voltage of the intermediate circuit (so called DC link) and reduces the intermediate circuit voltage until it falls below 60 V.

Furthermore, one or more low-voltage consumers 121 of the inverter, which are only schematically indicated, are arranged in the supply branch 120a, e.g. sensors (e.g. speed, angular position, temperature, etc.), communication devices (CAN transceiver, LIN transceiver, etc.), a (functional) safety control device, higher-level controller (such as a so-called MCU), energy management circuits (for example in the form of a so-called PMIC (power management IC, integrated circuit) or safety PMIC), etc.).

An inverter circuit 115 is also arranged on the supply side in the supply branch 120a. The inverter circuit 115 is used to connect the AC voltage terminals U, V, W (three in the example shown) of an electrical machine 500, which is not part of the power supply circuit 100, to the positive DC voltage terminal HV+ and the negative DC voltage terminal HV− of the high-voltage branch 110. For this purpose, the inverter circuit 115 can comprise a logic circuit or gate driver circuit for generating control signals, associated power supplies for the gate driver circuit and a number of semiconductor switches to be controlled by means of the control signals.

The inverter 1 (i.e. the entire device) has a housing from which the terminals HV+, HV−, B+, B−, U, V, W and, in particular, communication (e.g. CAN, LIN, etc.) and/or sensor (e.g. speed, angular position, temperature, etc.) and/or other terminals are led out. The inverter 1 can advantageously be structurally connected to the electrical machine 500, i.e. in particular attached to it.

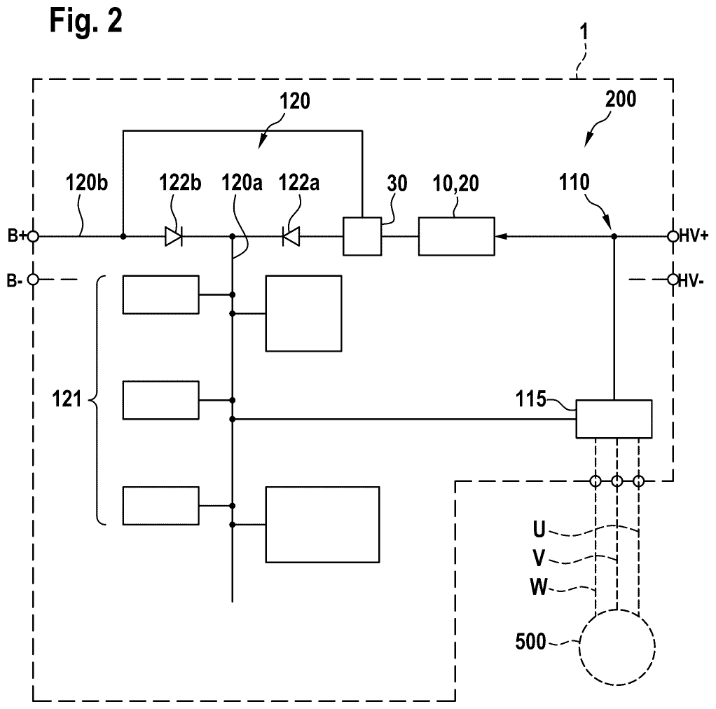

FIG. 2 shows an embodiment 200 of the power supply circuit, which corresponds to the embodiment according to FIG. 1 with regard to the high-voltage branch 110 and the low-voltage branch 120, but differs from the embodiment 100 according to FIG. 1 with regard to the discharge DC/DC converter 20. In particular, here the operating DC/DC converter 10 is also the discharge DC/DC converter 20. The mains branch 120b is connected on the low-voltage side of the DC/DC converter 10, 20 via a discharge circuit 30. The discharge circuit 30 can be part of the DC/DC converter 10, 20 or can be separate from it.

The discharge circuit 30 is shown schematically in FIG. 3 and, in the example shown, has a mains branch disconnector 31 for connecting the mains branch 120b to the discharge DC/DC converter 20 and disconnecting it therefrom, and a supply branch disconnector 32 for connecting the supply branch 120a to the operating DC/DC converter 10 and disconnecting it therefrom. Mains branch disconnector 31 and supply branch disconnector 32 can each be optionally designed as an electronic switch (e.g. semiconductor switch, transistor) or mechanical switch (e.g. relay). Furthermore, the discharge circuit 30 also has the blocking circuit designed as a diode 33 in order to prevent a current flow from the mains branch 120b into the discharge DC/DC converter 10, 20, and the current intensity determining device 34 in order to regulate a current flow into the mains branch 120b, here in particular in conjunction with a mains branch disconnector 31 designed as a semiconductor switch. The current intensity determining device 34 can also be implemented here in the discharge DC/DC converter 20. The current intensity determining device 34 can also be implemented here as shown in FIGS. 4 and 5, whereby in particular in the case of FIG. 5 the semiconductor switch 31 and 343 can be the same. The supply branch disconnector 32 can also be omitted.

In the various embodiments shown, the power supply circuit 100, 200 can be operated in a first operating mode (normal operating mode) such that current or energy flows from the high-voltage branch 110 via the operating DC/DC converter 10 into the supply branch 120a. At the same time, no current is usually conducted from the high-voltage branch 110 into the supply branch 120b in the first operating mode.

In the embodiment shown in FIG. 1, this can be realized in such a way that the operating DC/DC converter 10 is operated normally and the discharge DC/DC converter 20 is deactivated. In the embodiment shown in FIG. 2, this can be realized in such a way that the operating DC/DC converter 10 is operated normally and the discharge circuit 30 is controlled in such a way that the mains branch disconnector 31 is open and the supply branch disconnector 32 is closed (or substituted by a direct connection, i.e. not present at all).

In the various embodiments shown, the power supply circuit 100, 200 can be operated in a second operating mode (discharge mode) in such a way that current or energy flows from the high-voltage branch 110 via the discharge DC/DC converter 20 into the mains branch 120b. The low-voltage level is safe to touch. Any high-voltage energy sources present in the vehicle, such as the electric machine 500 or a high-voltage energy storage system, are conveniently disconnected from the high-voltage network by appropriate switches upstream of the energy supply circuit, so that the voltage level in the high-voltage branch 110 (and thus in the connected high-voltage network) drops from the high-voltage level and reaches the low-voltage level after a short time. The energy to be transferred is mainly contained in intermediate circuit capacitances (DC link capacitors) in the high-voltage network. The current intensity of the current flowing into the mains branch 120b can also be regulated.

In the embodiment shown in FIG. 1, this can be realized in such a way that the operating DC/DC converter 10 is deactivated or operated as an electrical load/energy sink and the discharge DC/DC converter 20 is operated in such a way that it converts the high-voltage voltage present on the input side into the low voltage on the output side. The discharge DC/DC converter 20 or the current intensity determining device 34 as shown in FIG. 5 can simultaneously regulate the current intensity if desired.

In the embodiment shown in FIG. 2, this can be realized in different ways. In any case, the operating DC/DC converter 10 is now operated as a discharge DC/DC converter 20, whereby it converts the high-voltage voltage present on the input side into the low voltage on the output side. The mains branch disconnector 31 is closed. In conjunction with a current intensity measurement 34 of the current flowing through the mains branch disconnector 31, the mains branch disconnector 31, if it is designed as a semiconductor switch, can simultaneously regulate the current intensity if desired. A current intensity determining device 34 as shown in FIG. 5 can also regulate the current intensity if desired

In a first variant, the supply branch disconnector 32 is also closed (or not present). In this case, the energy or current from the high-voltage branch 110 can also be used to supply the supply branch 120a or the low-voltage loads 121 there in parallel with discharging.

In another variant, the supply branch disconnector 32 is open. The low-voltage loads 121 can then be supplied from the mains branch 120b. In this case, a time delay can be provided between the closing of the mains branch disconnector 31 and the opening of the supply branch disconnector 32 in order not to switch the output side of the DC/DC converter open, i.e. to maintain an uninterrupted current flow via the DC/DC converter in order to avoid damage to the vehicle electrical network or the DC/DC converter.

In both cases, the low-voltage consumers continue to be supplied with power and can therefore also fulfill safety-critical functions, which should not be dispensed with for as long as possible even in the event of a high-voltage fault.

In embodiments without the diode 33 or with a bypass switch for the diode, the power supply circuit can also be operated in a third operating mode (regenerative mode) such that current or energy flows from the mains branch 120b via the discharge DC/DC converter 20 back into the high-voltage branch 110. This is advantageous if the event triggering the discharge mode (e.g. a fault in the inverter circuit) is rectified or resolved quickly enough and/or there is surplus energy in the low-voltage network that would otherwise be lost.

In the embodiment shown in FIG. 1 without the diode 33 or with a conductive bypass switch for the diode, this can be realized in such a way that the operating DC/DC converter 10 remains deactivated and the discharge DC/DC converter 20 is operated in the opposite direction so that it converts the low voltage present on the input side into a voltage with the high-voltage level on the output side. The use of a bidirectional discharge DC/DC converter 20 is advantageous for this purpose.

In the embodiment shown in FIG. 2 without the diode 33 or with a conductive bypass switch for the diode, this can be realized in such a way that the mains branch disconnector 31 is closed and the operating/discharge DC/DC converter 10, 20 is operated in the opposite direction as a “regenerative” DC/DC converter, whereby it converts the low voltage applied on the input side into a voltage with the high-voltage level on the output side. In this case, the energy is fed into the high-voltage branch.

In order to carry out the method and control the aforementioned DC/DC converters and switches, a computing unit 400 can be provided, which is set up in terms of programming and/or circuitry to carry out the corresponding steps.

In the present case, for example, the computing unit 400 is set up to output a discharge control signal S, which is distributed to the corresponding receivers, if a corresponding trigger situation exists, e.g. an accident, a fault in the inverter circuit 115 (which leads, for example, to an overvoltage in the high-voltage branch 110), etc.

For example, the discharge control signal S can be output to the inverter circuit 115 to cause the electrical machine 111 to be disconnected from the high-voltage branch 110. Alternatively or additionally, the inverter circuit 115 can be switched to a safe state, e.g. an active short circuit, in which all HV switches or all LS switches are closed. Alternatively or preferably additionally, high-voltage energy storage devices in a high-voltage network of the vehicle connected to the high-voltage terminals HV+, HV− can be disconnected from the high-voltage network.

For example, the discharge control signal S can be output to the discharge circuit 30 to cause the mains branch disconnector 31 and the supply branch disconnector 32 to be switched accordingly as described above, or to the current intensity determining device 34 as shown in FIG. 5 to start the discharge process.

For example, the discharge control signal S can be output to the discharge DC/DC converter 20 and the operating DC/DC converter 10 to cause them to be operated accordingly as described above. If necessary, an intermediate stage 401 can be provided which, in addition to an operating mode (ON/OFF, direction), also specifies an output voltage level for the operating DC/DC converter 10 or discharge DC/DC converter 20. In this case, the discharge control signal S can be a pure trigger signal which, for example, requests a discharge operating mode by means of a LOW level.

What is claimed is:

1. A method for operating a power supply circuit (100, 200) in an inverter (1) for driving an electrical machine (500), the power supply circuit (100, 200) in the inverter (1) comprising:
a high-voltage branch (110) with a high-voltage level,
a low-voltage branch (120) with a low-voltage level, the low-voltage branch (120) having a supply branch (120a) for distributing current to components of the inverter (1) and a mains branch (120b) for connection to a low-voltage network,
an operating DC/DC converter (10), which is connected on the one hand to the high-voltage branch (110) and on the other hand to the low-voltage branch (120),
a discharge DC/DC converter (20), which is connected on the one hand to the high-voltage branch (110) and on the other hand to the mains branch (120b),
the high-voltage level being higher than the low-voltage level,
wherein the method comprises the steps of:
in a first operating mode, conducting current from the high-voltage branch (110) via the operating DC/DC converter (10) into the supply branch (120a), wherein no current is conducted from the high-voltage branch (110) via the discharge DC/DC converter (20) into the mains branch (120b),
in a second operating mode, conducting current from the high-voltage branch (110) via the discharge DC/DC converter (20) into the mains branch (120b).

2. The method according to claim 1, wherein the operating DC/DC converter (10) and the discharge DC/DC converter (20) are the same DC/DC converter.

3. The method according to claim 1, comprising, in a third operating mode, conducting current from the mains branch (120b) via the discharge DC/DC converter (20) into the high-voltage branch (110).

4. The method according to claim 1, wherein a discharge circuit (30) is used, the discharge circuit (30) comprising a mains branch disconnector (31) for connecting and disconnecting the mains branch (120b) to and from the discharge DC/DC converter (20), and/or a supply branch disconnector (32) for connecting and disconnecting the supply branch (120a) to and from the operating DC/DC converter (10).

5. The method according to claim 4, wherein in the first operating mode the supply branch disconnector (32) is closed and the mains branch disconnector (31) is open.

6. The method according to claim 5, wherein in the second operating mode the mains branch disconnector (31) and the supply branch disconnector (32) are closed.

7. The method according to claim 5, wherein in the second operating mode the mains branch disconnector (31) is closed and the supply branch disconnector (32) is open.

8. The method according to claim 7, wherein the mains branch disconnector (31) is closed first and the supply branch disconnector (32) is opened with a delay.

9. The method according to claim 1, wherein in the second operating mode the current flowing from the high-voltage branch (110) via the discharge DC/DC converter (20) into the mains branch (120b) is regulated to a set current intensity.

10. The method according to claim 9, wherein the current is controlled by controlling a semiconductor switch (343, 31).

11. The method according to claim 1, wherein in the second operating mode the discharge DC/DC converter (20) is operated with constant voltage at the mains branch (120b).

12. A computing unit (400) adapted to perform a method according to claim 1.

13. A power supply circuit (100, 200) in an inverter (1) for driving an electrical machine (500), the power supply circuit (100, 200) comprising
a high-voltage branch (110) with a high-voltage level,
a low-voltage branch (120) with a low-voltage level, the low-voltage branch (120) having a supply branch (120a) for distributing current to components of the inverter (1) and a mains branch (120b) for connection to a low-voltage network,
an operating DC/DC converter (10), which is connected on the one hand to the high-voltage branch (110) and on the other hand to the low-voltage branch (120),
a discharge DC/DC converter (20), which is connected on the one hand to the high-voltage branch (110) and on the other hand to the mains branch (120b),
wherein the low-voltage branch (120) is arranged to supply components (121, 115) of the inverter with energy,
the power supply circuit (100, 200) further comprising a computing unit (400) for performing a method comprising the steps of:
in a first operating mode, conducting current from the high-voltage branch (110) via the operating DC/DC converter (10) into the supply branch (120a), wherein no current is conducted from the high-voltage branch (110) via the discharge DC/DC converter (20) into the mains branch (120b),
in a second operating mode, conducting current from the high-voltage branch (110) via the discharge DC/DC converter (20) into the mains branch (120b).

14. The power supply circuit (100, 200) according to claim 13, further comprising a discharge circuit (30) which can be switched in such a way that the high-voltage branch (110) is either electrically connected to the mains branch (120b) via the discharge DC/DC converter (20) or is electrically isolated from the mains branch (120b).

15. The power supply circuit (100, 200) according to claim 13, wherein the discharge circuit (30) is switchable such that the high-voltage branch (110) is either electrically connected to the low-voltage branch (120) via the operating DC/DC converter (20) or is electrically isolated from the low-voltage branch (120).

16. The power supply circuit (100, 200) according to claim 13, further comprising a current intensity determining device (34) with a semiconductor switch (343) for regulating a current intensity from the high-voltage branch (110) into the mains branch (120b).

17. An inverter (1) comprising a power supply circuit (100, 200) according to claim 13 and an inverter circuit (115), the inverter circuit (115) comprising a number of semiconductor switches to be driven by means of drive signals, further comprising low-voltage terminals (B+, B−) adapted to be connected to a low-voltage network of a vehicle, high-voltage terminals (HV+, HV−) adapted to be connected to a high-voltage network (1) of the vehicle, and machine terminals (HV−, HV−) adapted to be connected to stator windings of the electric machine (500).
